(19) United States
(12) Patent Application Publication
(10) Pub. No.: US 2014/0304110 A1
(43) Pub. Date: Oct. 9, 2014

(54) PROCUREMENT PROCESS UTILIZING A LIGHT SENSOR

(71) Applicant: W.W. Grainger, Inc., Lake Forest, IL (US)

(72) Inventors: George C. Rimnac, Jr., Long Grove, IL (US); David Brenner, Round Lake, IL (US); Michael Cooney, Evanston, IL (US); Geoffry A. Westphal, Evanston, IL (US); Erwin Munoz Cruz, Hoffman Estates, IL (US)

(73) Assignee: W.W. Grainger, Inc., Lake Forest, IL (US)

(21) Appl. No.: 14/208,049

(22) Filed: Mar. 13, 2014

Related U.S. Application Data
(60) Provisional application No. 61/792,898, filed on Mar. 15, 2013.

(51) Int. Cl. G01J 1/42; G06Q 30/06

(52) U.S. Cl. CPC G01J 1/42; G06Q 30/0633; G01J 2001/4247
USPC 705/26.8

(57) ABSTRACT

A system for managing a procurement process uses an ambient light sensor to detect an operating anomaly regarding at least one light source. A procurement system operatively coupled to the light sensing system receives information indicative of the detected operating anomaly of the at least one light source and, in response thereto, initiates the procurement process to obtain a replacement for the at least one light source.

### RELATED APPLICATION INFORMATION

This application claims the benefit of U.S. Provisional Application No. 61/792,898, filed on Mar. 15, 2013, the disclosure of which is incorporated herein by reference in its entirety.

### FIELD OF THE DISCLOSURE

The present disclosure is generally related to an automated procurement process, and more particularly to a procurement process utilizing a light sensor.

### BACKGROUND OF RELATED ART

Fault detection, such as by way of example, networked appliances is generally known in the art. By way of example, U.S. Published Application No. 2011/0060553 describes a home appliance that functions to output product information as a sound signal. A service center remotely performs fault diagnosis of the home appliance by receiving the sound signal, detecting the product information from the sound signal, and checking the state of the home appliance using diagnostic data that is also included in the outputted product information.

In addition, U.S. Pat. No. 7,340,414 describes a refrigerator capable of transmitting and receiving information over a network and having an automatic food ordering function. In this patent, residual amounts of food articles stored in containers of the refrigerator are measured through sensors installed in the containers and then displayed on a screen of a display unit, thereby enabling a user to easily recognize the residual amounts of the food articles stored in the refrigerator without opening the door of the refrigerator. The measured residual amounts of the food articles are compared with minimum proper amounts of the food articles preset by the user. In the case where the measured residual amount of a specific one of the food articles is smaller than the minimum proper amount of the specific food article, the specific food article is automatically ordered and delivered.

Still further, U.S. Published Application No. 2012/0316984 describes an appliance having a processing device and at least one sensor in communication with the processing device where the sensor gathers data indicative of usage of a consumable with the appliance. The gathered data is used to determine an amount of the consumable remaining and, when the amount of the consumable remaining is at a predetermined level, a notification is provided to indicate to a user that the consumable needs to be replaced.

While such exemplary networked appliances work for the described purposes, a need exists for improved sensing system, particularly for use in a procurement process.

### SUMMARY

Described herein are exemplary systems and methods for managing a procurement process. The described systems and methods use a light sensor to detect an operating anomaly regarding at least one light source. A procurement system operatively coupled to the light sensing system receives information indicative of the detected operating anomaly of the at least one light source and, in response thereto, initiates the procurement process to obtain a replacement for the at least one light source.

### BRIEF DESCRIPTION OF THE DRAWINGS

For a better understanding of the system and method for associating item lists with geographical locations described hereinafter reference may be had to preferred embodiments shown in the following drawings in which:

FIG. 1 illustrates a block diagram on an exemplary system having a light sensor for use in a procurement process; and

FIG. 2 is a flow chart depicting an exemplary method for using a light sensor in a procurement process.

### DETAILED DESCRIPTION

The following description of example methods and apparatus is not intended to limit the scope of the description to the precise form or forms detailed herein. Instead the following description is intended to be illustrative so that others may follow its teachings.

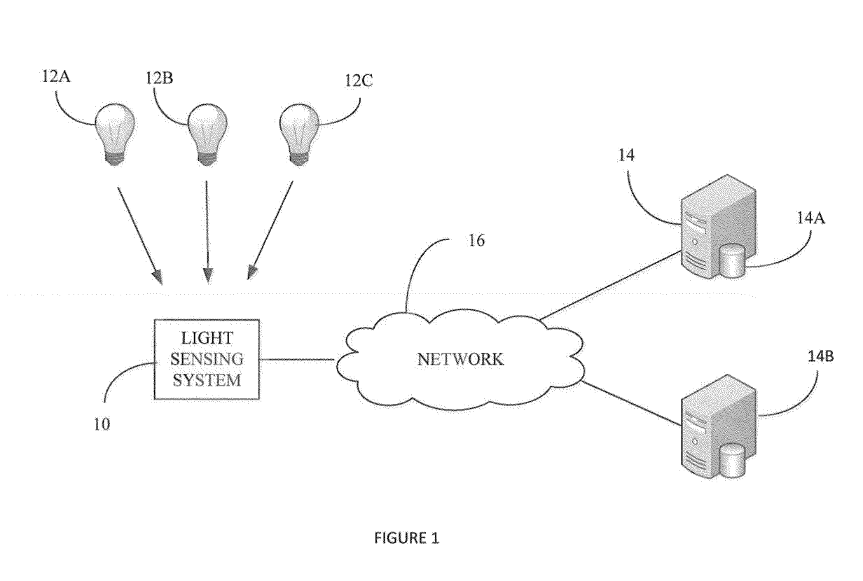

FIG. 1 illustrates a block diagram of an example system 2 for using a light sensor in a procurement process. Generally, the system 2 includes a light sensing system 10 which is adapted to sense an illumination pattern that is created by plural sources of light, e.g., light emitting elements 12A, 12B, and 12C. The light sensing system 10 is, in turn, adapted to communicate with a system server 14 via a communications network 16. The system server 14 may additionally communicate, as necessary, with other third part systems servers 18 for purposes which will become apparent given the description that follows.

In one embodiment, the light sensing system 10 comprises an integrated and/or external light sensing device, such as a light sensing element, camera, video camera, or the like that is capable of sensing light in the visible and/or non-visible light spectrums. The light sensing device would, in turn, be in communication with a processing device adapted to execute instructions stored on non-transitory computer readable media. As will be appreciated by those of ordinary skill in the art, the executable instructions would reside in program modules which may include routines, programs, objects, components, data structures, etc. that perform particular tasks or implement particular abstract data types. Further, while illustrated in the context of a single light sensing system 10, those of ordinary skill in the art will also appreciate that the various tasks described hereinafter may be practiced in a distributed environment having multiple processing devices linked via a local or wide-area network and/or a cloud computing environment whereby the executable instructions stored on such non-transitory computer readable media may be associated with and/or executed by one or more of devices in communication with the light sensing system 10, including the sever system 14.

As noted, the light sensing system 10 may also utilize logical connections to one or more remote processing devices, such as the system server 14 having associated data repository 14A. The example data repository 14A will include data suitable for use in the procurement process including, for example, the specific types of light emitting elements 12A, 12B, 12C that are being monitored by the light sensing system 10, the owner/operator of the facility having the light emitting elements 12A, 12B, 12C, the location at which the light emitting elements 12A, 12B, and 12C are installed, and/or other information necessary to facilitate an ordering and delivery of any required replacement light emitting elements as well as to facilitate payment therefor. It will therefore be appreciated that the system server 14 may be embodied as any type of device having processing capabilities. Furthermore, it will be appreciated that the system server 14 need not be implemented as a single device but may be implemented in a manner such that the tasks performed by the system server 14 are distributed amongst a plurality of processing devices/databases located at different geographical locations and linked through the communication network 16. As necessary, the system server 14 may also have logical connections to other third party systems 18 via the communications network 16 and via such connections, will be associated with data repositories that are associated with such other third party systems 18. Such third party systems 18 may include, without limitation, systems of banking, credit, or other financial institutions, systems of third party providers of goods and/or services, systems of shipping/delivery companies, etc. It will also be understood that communications between the various devices may be exchanged via a further processing device, such as a network router (not shown), that is responsible for network routing. Thus, within such a networked environment, e.g., the Internet, World Wide Web, LAN, cloud, or other like type of wired or wireless network, it will be appreciated that program modules used by the various devices or portions thereof, may be stored in the non-transitory memory storage device(s) of one or more of the various devices.

Still further, the light sensing system 10 may include any suitable sensing device(s) such as, for example, an ambient light sensor. In this example, an ambient light sensor is a specific version of a photodiode that is capable of converting light into a voltage or current, dependent upon the mode of operation. In one example, the ambient light sensor is a PN junction or a PIN structure having a specific field of view.

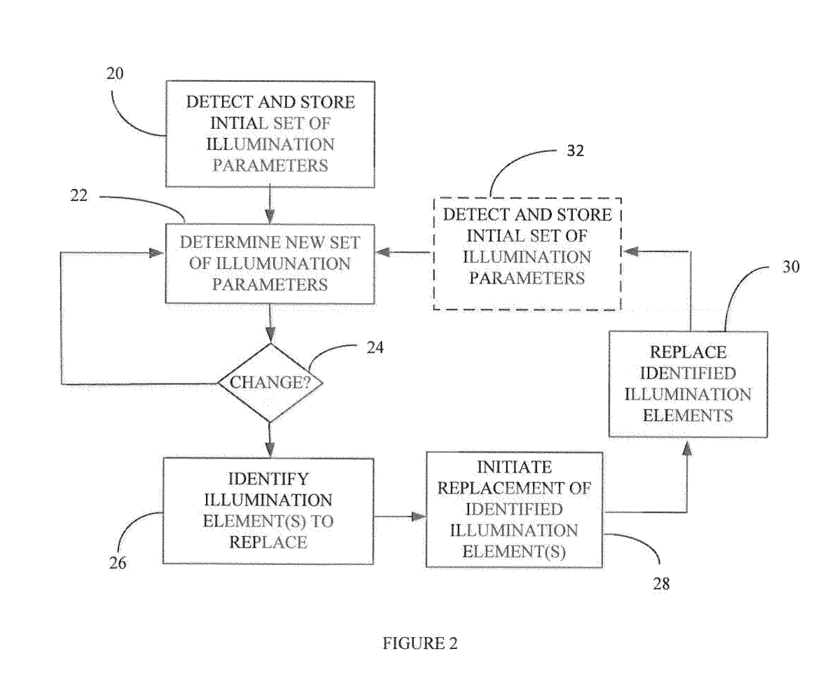

In operation, the light sensing system 10 is utilized to detect and store 20 an initial set of illumination pattern parameters as shown in FIG. 2. To this end, as described in U.S. Published Application No. 2012/0299510 (which application is incorporated herein by reference in its entirety) the light sensing system 10 is equipped with a light sensing device for measuring an illumination pattern provided by the light emitting elements 12A, 12B, 12C. More specifically, the light emitting elements 12A, 12B, and 12C are each configured to emit an illumination pattern which together form a joint illumination pattern as perceived by a user. Accordingly, the light sensing system 10 may be configured to measure the joint illumination pattern, individual illumination patterns, and/or sub-combinations of the individual illumination patterns provided by the light emitting elements 12A, 12B, 12C. The sensed and detected base-line illumination pattern parameters are then stored in memory whereupon they are available for use in determining if one or more of the light emitting elements 12A, 12B, 12C fails or is in the process of failing, e.g. stops to emit light due to an empty battery, breakage, or removal from its original location, emits less light due to a pending failure, etc.

More particularly, the light sensing system 10 functions to continually or periodically sense 22 the joint illumination pattern that is being provided by the light emitting elements 12A, 12B, and 12C. This operationally sensed joint illumination pattern parameters are then compared 24 against the base line joint illumination pattern parameters to determine if the operational joint illumination pattern parameters have changed in comparison to the base line joint illumination parameters. If there is a detected change in the operational joint illumination pattern parameters as compared to the base line joint illumination pattern parameters, the system can then, as necessary, compare the operational joint illumination pattern parameters against the individual illumination pattern parameters and/or the sub-combinations of the individual illumination pattern parameters to look for a match or near match and to thereby determine 26 which one or more light emitting elements 12A, 12B, 12C have failed or are in the process of failing.

Once it is determine which one or more light emitting elements 12A, 12B, 12C are in need of replacing, the light sensing system 10 may then issue a communication to the system server 14. The communication will preferably include data indicative of the location of the light sensing system 10 as well as the identity of the one or more light emitting elements 12A, 12B, 12C that are in need of replacement. In this regard, it will be appreciated that the individual light emitting elements 12A, 12B, 12C can be provided with a unique identifier, such as an installation location within the area that is being monitored by the light sensing system 10, and that such unique identifiers would be mapped to the various base line illumination patterns that are captured by the light sensing system 10.

In response to a receipt of the communication from the light sensing system 10, the system server 14 will initiate 28 the performance of steps necessary for procuring replacements for the failed or failing one(s) of light emitting elements 12A, 12B, 12C. In this regard, the system server 14 will have access to a data repository (e.g., data repository 14A, 14B) in which the data included in the communication received from the light sensing system 10 is cross-referenced to the types of lighting emitting elements 12A, 12B, 12C that were initially installed in the area that is being monitored by the light sensing system 10 (to thereby provided for a failed light emitting element to be identically replaced) as well as any such data that is needed to obtain the replacement light emitting elements from inventory, to deliver the replacement light emitting elements to the area, to install the replacement light emitting, to secure payment for the replacement light emitting elements, etc. as needed. As noted above, to the extent necessary the system server 14 can communicate with other servers 18 as required to meet these procurement goals. While not required, once the replacement light emitting elements are installed 30 in the area, the light sensing device 10 can be used to capture 32 new base-line illumination pattern parameters for use in the manner above-described.

The procurement process can be set based on variable requirements; order immediately, batch, add to next cycled order, etc. In addition, other procurement process capabilities can be integrated as well; order management, mobile, visual confirmations, auto-replenishment, etc.

In a typical scenario such as an office workplace environment, the light sensing system 10 will be appropriately spaced based on the type of ambient light sensor utilized (i.e., the operational and technical specifications thereof) and its scanning capabilities to ensure the specific room has sufficient sensor coverage, notably that the light sensing system 10 can detect each of the lights 12A, 12B, 12C, or other source of illumination that are of interest. In addition, with the advancement of other types of sensing technologies, a virtual rendering of the room can also be depicted and/or rendered in the light sensing system 10 to display an image of the room and placement of all the lighting sources 12A, 12B, 12C and their respective lighting condition. The light sensing system 10 manages this information and integrates this into a procurement management system (e.g., a vendor order management system) through network 16, wherein the order management system includes the capabilities of executing a replenishment order. As stated earlier, the overall procurement process can accommodate a variety of ordering and management scenarios.

In a first example of operation, the light sensing system 10 detects low light levels from one or more lights 12A, 12B, 12C. In sensing the low light conditions, the light sensing system 10 provides an alert to any of the control processors 14. Based on the image reproduction of that area stored in the data repositories 14A, 14B, a virtual rendering of the displayed room is presented to the user on a display of a client computing device indicating the specific light that is out, dimmed, and/or otherwise operating improperly. The user can initiate the next step process whether it is to disregard/hold, trigger a replacement order, or let the system self-auto replenish.

In another example, the light sensing system 10 detects an abnormal condition and a light replacement process is triggered and based on an auto-replenishment process and light replacements are batched based on a specific count. The order replenishment triggers the procurement process which automatically submits an order to the appropriate supplier based on a criteria set; availability, price, location, installation time, etc.

In still another example, the procurement process is similarly triggered based on light replacement sensing criteria, such as abnormal operation, time since last install, etc. In this scenario, the procurement process integrates a services process in which the user requires the installation of the lights. The installation services can either be internal or external labor resources. In the case of a supplier that provides both the product and installation service, once the replenishment order is triggered, in this scenario the criteria is immediate replacement, an order is sent to the closest service truck that has the inventory to fulfill the order. The controller processor based on known algorithms may identify the nearest service truck to the customer with available inventory and triggers a service job. The controller process will have routing logic to ensure efficient time of the service provider is utilized; based on geo-location services, types of lights, number of lights required to be replaced and installed, etc. The alerts can also provide the customer tracking capabilities indicating location of service truck and estimated time of arrival.

In yet another example, this describes the capabilities of the information collected by the control processor over a set period of time. Various trending reports can be generated showing procurement trends on a wide variety of data points; types of light bulbs, environment conditions, installation service levels, replenishment costs, cost savings, frequency, etc.

It will be further appreciated that the systems and methods for procurement described herein may include additional information and/or data regarding the location and/or the parts associated with the light sources 12A, 12B, 12C. For example, the light sensing system 10, and/or the networked procurement system may be able to detect and/or identify the exact location of the lights sources 12A, 12B, 12C, and/or the light sensing system 10 itself. For example, the procurement system may utilize geo-location and/or other suitable identification method to provide relevant data regarding the light sources. Still further, as noted above, the data repository may include a map and/or listing of associated parts for the identified location to assist in the ordering of the specific part with little or no intervention from the user.

The example light sensing system 10 and/or lights 12A, 12B, 12C may be suitably powered by any known or to be developed technology. For example, the components may be hard-wired, solar powered, light powered, battery operated, self-charging, AC and/or DC powered, etc. In this regard, it will be appreciated that light powered sensors can be used to detect an initial problem with the lights 12A, 12B, 12C when, for example, insufficient power is being obtained by the sensor(s) from the lights 12A, 12B, 12C. This detected problem may be used to trigger further detection as noted above and/or be used to signal an operator to inspect the lights.

Still further, in order to conserve power, the light sensing system may be programmed to periodically monitor and/or evaluate the related light environment. In particular, the system 10 can “wake up” for a very short time, do its work, and return to a powered-down and/or hibernation state. In addition, it will be understood that one light sensing device, as a part or whole of the light sensing system 10 can monitor multiple light sources as disclosed. Alternatively, there may be a one-to-one, many-to-one, or one-to many relationship, such as for instance, multiple light sensors monitoring the light.

Yet further, as noted, in one example the light sensing system 10 can monitor how long a light source has been working and predict lamp outages, suggest preemptive replacement of the devices, or predict life spans based upon the monitored light. The system 10 can provide the user with valuable statistics on lamp and/or service performance, lamp life, etc. by measuring for example, the performance of the light and/or how long a lamp is out before it gets replaced, e.g., efficiency of replacement service.

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents.

We claim:

1. A system for managing a procurement process via an ambient light sensor, the system comprising:
at least one light source;
a light sensing system associated with the at least one light source used to detect an operating anomaly regarding the at least one light source; and
a procurement system operatively coupled to the light sensing system, the procurement system receiving information indicative of the detected operating anomaly of the at least one light source and initiating a procurement process for a replacement light source in response to the received information.

2. The system as recited in claim 1, wherein the light sensing system detects light emitted from the at least one light source in a visible light spectrum.

3. The system as recited in claim 1, wherein the light sensing system detects light emitted from the at least one light source in a non-visible light spectrum.

4. The system as recited in claim 1, wherein the light sensing system establishes a base-line illumination pattern for the at least one light source, wherein the light sensing system captures a further illumination pattern for the at least one light source, and wherein the light sensing system compares the further illumination pattern for the at least one light source to the base-line illumination pattern for the at least one light source to thereby detect the operating anomaly of the at least one light source.

5. The system as recited in claim 4, wherein the light sensing system periodically captures the further illumination pattern.

6. The system as recited in claim 4, wherein the light sensing system continually captures the further illumination pattern.

7. The system as recited in claim 1, wherein the light sensing system is used to detect an operating anomaly regarding a plurality of light sources including the at least one light source.

8. The system as recited in claim 7, wherein the light sensing system detects light emitted from the plurality of light sources in a visible light spectrum.

9. The system as recited in claim 7, wherein the light sensing system detects light emitted from the plurality of light sources in a non-visible light spectrum.

10. The system as recited in claim 7, wherein the light sensing system establishes a base-line illumination pattern for the plurality of light sources, wherein the light sensing system captures a further illumination pattern for the plurality of light sources, and wherein the light sensing system compares the further illumination pattern for the plurality of light sources to the base-line illumination pattern for the plurality of light sources to thereby detect the operating anomaly of the at least one light source.

11. The system as recited in claim 10, wherein the light sensing system periodically captures the further illumination pattern.

12. The system as recited in claim 10, wherein the light sensing system continually captures the further illumination pattern.

13. The system as recited in claim 1, comprising a computer having a display wherein the computer is operatively coupled to the light sensing system and wherein the computer causes a display in the display of a virtual room showing the at least one light source.

14. The system as recited in claim 13, wherein the virtual room shows that at least one light source with an indicator to represent the operating anomaly of the at least one light source.

15. The system as recited in claim 1, wherein the procurement system initiates a procurement process for a replacement light source by automatically ordering the replacement light source for delivery to a predetermined location.

16. The system as recited in claim 1, wherein the predetermined location comprises a location having the at least one light source.

17. The system as recited in claim 1, wherein the operating anomaly of the at least one light source comprises a failure of the at least one light source.
